(19) United States
(12) Patent Application Publication
(10) Pub. No.: US 2026/0045113 A1
(43) Pub. Date: Feb. 12, 2026

(54) AUTO REPLY DEVICE, AUTO REPLY METHOD, AND COMPUTER PROGRAM FOR AUTO REPLY

(71) Applicant: TOYOTA JIDOSHA KABUSHIKI KAISHA, Toyota-shi (JP)

(72) Inventors: Yuta TSUZUKI, Tokyo-to (JP); Yasufumi KAWANO, Tokyo-to (JP)

(73) Assignee: TOYOTA JIDOSHA KABUSHIKI KAISHA, Toyota-shi (JP)

(21) Appl. No.: 19/229,248

(22) Filed: Jun. 5, 2025

(30) Foreign Application Priority Data
Aug. 7, 2024 (JP) 2024-130972

(51) Int. Cl. G06V 40/10; G06F 40/166; G06V 10/26; G06V 10/764; G10L 15/22; G10L 15/24

(52) U.S. Cl. CPC G06V 40/10; G06V 10/26; G06V 10/764; G06F 40/166; G10L 15/22; G10L 15/24

(57) ABSTRACT

An auto reply device includes a processor configured to recognize one of at least one person represented in an image, and generate an answer to a question related to a recognized person by inputting identifying information for identifying the recognized person, the image, and the question into a generation model that has been trained to generate the answer.

### FIELD

The present invention relates to an auto reply device that automatically replies to a user's question, an auto reply method, and a computer program for auto reply.

### BACKGROUND

A proposed generation model (vision language model, hereafter “VLM”) generates an answer to a question related to an image by referring to the image upon input of the image and the question given as text (see Yash Goyal et al., “Making the V in VQA Matter: Elevating the Role of Image Understanding in Visual Question Answering,” International Journal of Computer Vision, Volume 127, Issue 4, April 2019, pp 398-414, https: //doi.org/10.1007/s11263-018-1116-0).

### SUMMARY

A VLM gives a typical answer to an inputted question about an object represented in an image to the best of the VLM's knowledge. However, a VLM may fail to give an appropriate answer to a question about a particular one of multiple objects represented in an image. For example, when multiple persons are represented in an inputted image and a question about a particular one of these persons is inputted, a VLM cannot identify which of the persons is in question and may thus fail to generate an appropriate answer.

It is an object of the present invention to provide an auto reply device that can generate an appropriate answer to a question about a particular person represented in an image.

According to an embodiment, an auto reply device is provided. The auto reply device includes a processor configured to recognize one of at least one person represented in an image, and generate an answer to a question related to a recognized person by inputting identifying information for identifying the recognized person, the image, and the question into a generation model that has been trained to generate the answer.

In an embodiment, the processor further inputs positional information indicating the position of a human region representing the recognized person in the image into the generation model, together with the question.

In an embodiment, the processor pre-processes an image to mask the image except a human region representing the recognized person in the image, and uses the pre-processed image as the image to be inputted into the generation model.

In an embodiment, the processor is further configured to select whether the whole of the image or a pre-processed image obtained by pre-processing the image is to be inputted into the generation model, depending on the question, and the processor inputs the whole of the image or the pre-processed image, whichever is selected, into the generation model.

In an embodiment, the processor further selects whether positional information indicating the position of a human region representing the recognized person in the image is to be inputted into the generation model, depending on the question, and the processor further inputs the positional information into the generation model when the positional information is selected as input into the generation model.

According to another embodiment, an auto reply method is provided. The auto reply method includes recognizing one of at least one person represented in an image, and generating an answer to a question related to a recognized person by inputting identifying information for identifying the recognized person, the image, and the question into a generation model that has been trained to generate the answer.

According to still another embodiment, a non-transitory recording medium that stores a computer program for auto reply is provided. The computer program includes instructions causing a computer to execute a process including recognizing one of at least one person represented in an image, and generating an answer to a question related to a recognized person by inputting identifying information for identifying the recognized person, the image, and the question into a generation model that has been trained to generate the answer.

The auto reply device of the present disclosure has an advantageous effect of being able to generate an appropriate answer to a question about a particular person represented in an image.

### BRIEF DESCRIPTION OF DRAWINGS

FIG. 1 schematically illustrates the configuration of a vehicle equipped with an auto reply device.

FIG. 2 illustrates the hardware configuration of the auto reply device.

FIG. 3 is a functional block diagram of a processor of the auto reply device.

FIG. 4 is a diagram for explaining input and output of an answer generation model of the embodiment.

FIG. 5 is an operation flowchart of the auto reply device.

### DESCRIPTION OF EMBODIMENTS

An auto reply device, an auto reply method executed by the auto reply device, and a computer program for auto reply will now be described with reference to the attached drawings. The auto reply device recognizes one of at least one person represented in an image, and generates an answer to a question related to a recognized person by inputting identifying information for identifying the recognized person, the image, and the question into a generation model that has been trained to generate the answer.

The following describes an embodiment in which an answer to a question related to one of occupants of a vehicle is automatically generated by an auto reply device being mounted on the vehicle.

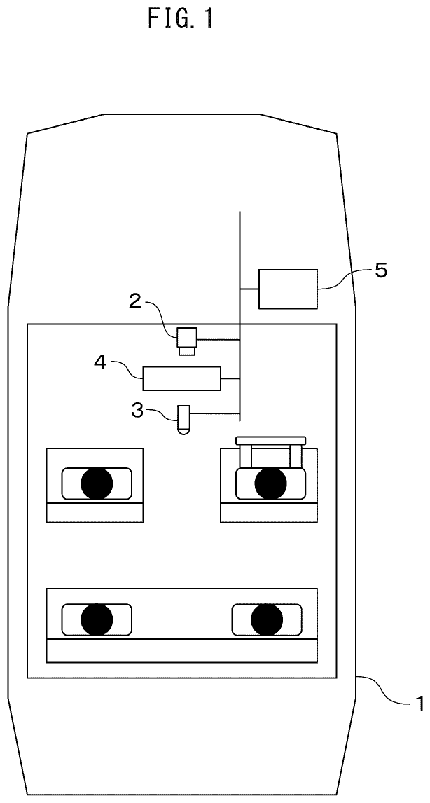

FIG. 1 schematically illustrates the configuration of a vehicle equipped with an auto reply device. In the present embodiment, the vehicle 1 includes a camera 2, at least one microphone 3, a notification device 4, and an auto reply device 5. The camera 2, the microphone 3, and the notification device 4 are communicably connected to the auto reply device 5.

The camera 2, which is an example of an image capturing unit, is mounted near the top of the windshield and oriented to the vehicle interior so that all the occupants in the vehicle 1 are included in a region to be captured by the camera. Every predetermined capturing period, the camera 2 generates an image representing the region to be captured and outputs the generated image to the auto reply device 5.

The at least one microphone 3 picks up a voice of one of the occupants in the vehicle 1 and outputs a voice signal representing the voice. To achieve this, each microphone 3 is mounted in the interior of the vehicle 1. Multiple microphones 3 may be arrayed, or mounted near respective seats in the interior of the vehicle 1.

The notification device 4 is provided in the interior of the vehicle 1 and notifies an occupant of an answer generated by the auto reply device 5. To achieve this, the notification device 4 includes, for example, at least one of a speaker or a display. When an answer signal representing an answer to an occupant is received from the auto reply device 5, the notification device 4 notifies the occupant of the answer by a voice from the speaker or by displaying a message, an image, or a video on the display.

The auto reply device 5 generates an answer to a question related to one of the occupants in the vehicle 1, and notifies the generated answer to an occupant of the vehicle 1 via the notification device 4.

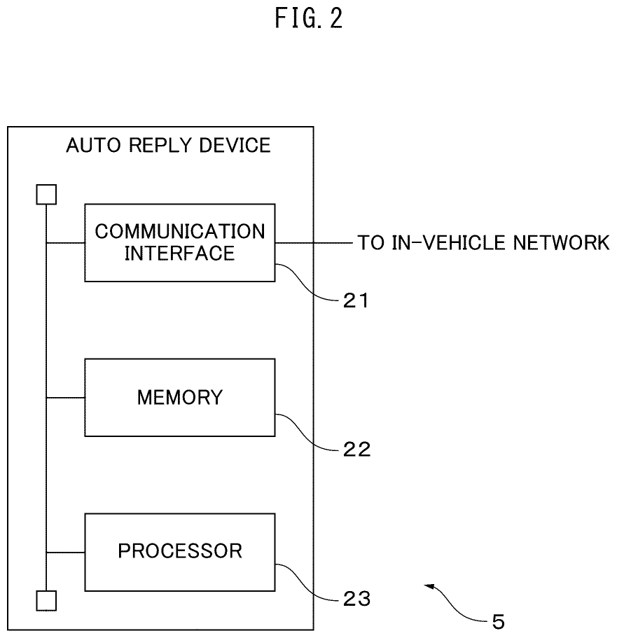

FIG. 2 illustrates the hardware configuration of the auto reply device 5. As illustrated in FIG. 2, the auto reply device 5 includes a communication interface 21, a memory 22, and a processor 23. The communication interface 21, the memory 22, and the processor 23 may be configured as separate circuits or a single integrated circuit.

The communication interface 21 includes an interface circuit for connecting the auto reply device 5 to another device inside the vehicle. The communication interface 21 passes an image received from the camera 2 and voice signals received from the individual microphones 3 to the processor 23. Further, the communication interface 21 outputs an answer signal received from the processor 23 to the notification device 4.

The memory 22, which is an example of a storage unit, includes, for example, volatile and nonvolatile semiconductor memories, and stores various types of data used in an auto reply process executed by the processor 23. More specifically, the memory 22 stores parameters specifying a classifier used for identifying an occupant represented in an image and parameters specifying a generation model for generating an answer. For each of one or more registered persons who are pre-registered, the memory 22 further stores a feature vector representing features of the registered person (hereafter a “register vector”) and identifying information (e.g., the name, a nickname, or an identification number of the registered person). Further, the memory 22 may temporarily store images received from the camera 2 and voice signals received from the individual microphones 3.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes an auto reply process.

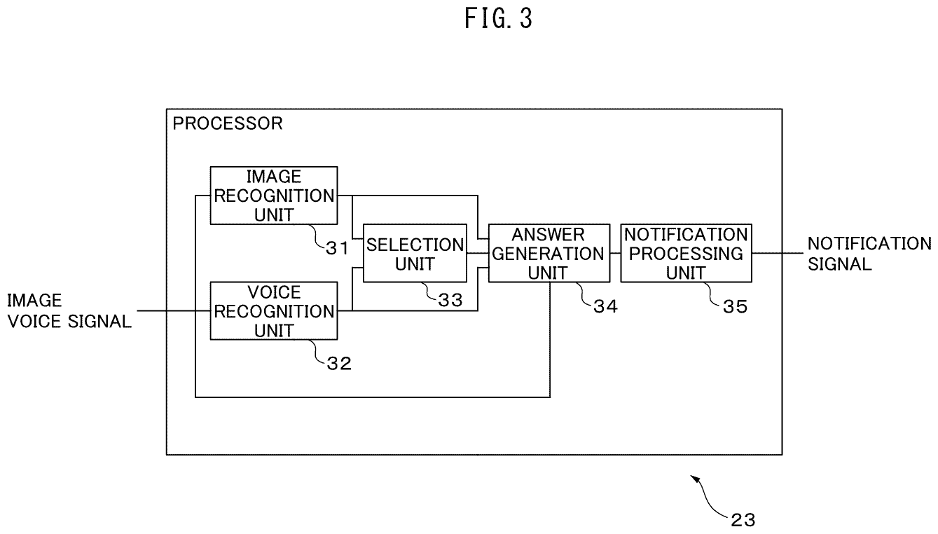

FIG. 3 is a functional block diagram of the processor 23, related to the auto reply process. The processor 23 includes an image recognition unit 31, a voice recognition unit 32, a selection unit 33, an answer generation unit 34, and a notification processing unit 35. These units included in the processor 23 are, for example, functional modules implemented by a computer program executed by the processor 23, or may be dedicated operating circuits provided in the processor 23.

The image recognition unit 31, which is an example of the recognition unit, recognizes individual occupants represented in an image generated by the camera 2 and representing the region to be captured in the interior of the vehicle 1. An occupant of the vehicle 1 is an example of a person to be recognized.

The image recognition unit 31 inputs an image into a classifier that has been trained to detect a region representing an occupant (hereafter a “human region”), thereby detecting a human region in the image. For each occupant in the interior of the vehicle 1, a human region representing the occupant is detected in this way. Such a classifier is configured as a deep neural network (DNN) having architecture of a convolutional neural network (CNN) type, e.g., Single Shot MultiBox Detector, or a DNN having an attention mechanism, e.g., Vision transformer. Alternatively, such a classifier may be configured as a classifier based on a machine learning technique other than a DNN, e.g., an AdaBoost classifier.

Next, the image recognition unit 31 inputs the detected individual human regions into a feature extractor that has been trained to extract a feature vector representing features of an occupant represented in a human region, thereby extracting a feature vector from each human region. Such a feature extractor is configured, for example, as a DNN pre-trained by “unsupervised learning,” such as Auto-Encoder or Stacked What-Where Auto-Encoders. In this case, the feature extractor includes, in order from the input side, an encoder that outputs a feature having a lower dimension than inputted data (in the present embodiment, a human region) and a decoder into which the feature outputted from the encoder is inputted. The feature extractor is pre-trained with a large number of images representing various persons so that data outputted from the decoder is the same as data inputted into the encoder. By inputting a human region into a trained feature extractor, a feature vector representing features of an occupant represented in the human region is obtained as features outputted by the encoder. The feature extractor may be configured as a DNN trained by a technique such as self-supervised learning.

For each detected human region, the image recognition unit 31 calculates the degrees of matching (e.g., cosine similarities) of the feature vector extracted from the human region with respective register vectors of the registered persons who are pre-registered. The image recognition unit 31 then identifies the occupant represented in the human region as a registered person having a maximum degree of matching. When the maximum of the degrees of matching is less than a predetermined matching threshold, the image recognition unit 31 may determine that the occupant represented in the human region is not any of the registered persons.

For each detected human region, the image recognition unit 31 further calculates the distances between the centroid of the human region in the image and reference positions in the image respectively corresponding to the positions of individual seats in the vehicle interior. The image recognition unit 31 then determines that the occupant represented in the human region is sitting on a seat corresponding to a reference position whose distance is the smallest.

For each detected human region, the image recognition unit 31 outputs identifying information of the occupant represented in the human region and positional information indicating the position of the human region in the image (e.g., the centroid of the human region) to the selection unit 33 and the answer generation unit 34. For an occupant different from any of the registered persons, the image recognition unit 31 outputs data meaning an unregistered person (e.g., text data “guest”) as identifying information of the occupant. Positional information may include information indicating the area of a human region (e.g., the coordinates of the upper left and lower right corners of a human region). Positional information may further include a flag indicating the position of a seat on which an occupant represented in a human region corresponding to the positional information is sitting.

The voice recognition unit 32 recognizes a question asked by one of the occupants, based on a voice signal picked up by the microphone 3 and representing a voice in the vehicle interior. To achieve this, the voice recognition unit 32 inputs a voice signal into a voice recognition model, thereby recognizing a question represented in the voice signal. Such a voice recognition model is configured, for example, as a DNN having an attention mechanism or a DNN having a recursive structure, such as a recurrent neural network (RNN). Alternatively, the voice recognition model may be configured as a GMM-HMM based on a mixture Gaussian distribution and a hidden Markov model or as a DNN-HMM based on a DNN and a hidden Markov model. The voice recognition model outputs a question represented in an inputted voice signal as text data. The voice recognition unit 32 may divide a voice signal into frames each having a predetermined length of time, extract a feature of the voice for each frame, and input the feature of each frame into the voice recognition model in chronological order, thereby recognizing a question represented in the voice signal. The feature of each frame may be, for example, a predetermined element of the cepstrum of the frame.

The voice recognition unit 32 outputs text data representing a question recognized from a voice signal to the selection unit 33 and the answer generation unit 34.

Depending on the question, the selection unit 33 selects whether the whole of the image or a pre-processed image is to be inputted into a generation model that has been trained to generate an answer to a question (hereafter an “answer generation model”). Details of the answer generation model will be described below, together with the answer generation unit 34.

The selection unit 33 refers to the text data representing a question received from the voice recognition unit 32 and the identifying information of the occupants represented in the image received from the image recognition unit 31. When the text data representing a question does not include identifying information of any of the occupants represented in the image, the selection unit 33 selects the whole image as input into the answer generation model. This is because the question does not relate to a particular occupant, and to generate an appropriate answer, it is probably required that the states of the individual occupants represented in the image can be referred to. For example, when the question is “Does everyone look hot?” the whole image is selected as input into the answer generation model.

When the text data representing a question includes identifying information of one of the occupants represented in the image and does not include a word related to the surroundings of the occupant, the selection unit 33 selects an image that is pre-processed to mask the region except the human region representing the occupant identified by the identifying information included in the text data, as input into the answer generation model. This prevents image information on occupants other than the occupant in question from being inputted into the answer generation model, facilitating generating an appropriate answer to the question. For example, when the question is “Is Mr. A sleeping?” an image that is pre-processed to mask the image except the human region representing occupant A is selected as input into the answer generation model. When the text data representing a question includes identifying information of multiple occupants represented in the image, the selection unit 33 selects an image that is pre-processed to mask the image except the human regions corresponding to their identifying information, as input into the answer generation model.

When the text data representing a question includes identifying information of one of the occupants represented in the image and a word related to the surroundings of the occupant, the selection unit 33 selects the whole image and positional information of the human region representing the occupant identified by the identifying information included in the text data, as input into the answer generation model. This enables paying attention to the occupant in question and his/her surroundings, facilitating giving an appropriate answer to a question about the occupant's action to his/her surroundings. For example, when the question is “Who is Mr. A talking with?” the whole image and positional information of the human region representing occupant A identified by the identifying information included in the text data of the question is selected as input into the answer generation model. Words related to the surroundings of an occupant may be pre-registered and pre-stored in the memory 22.

The selection unit 33 notifies the answer generation unit 34 of information indicating the selected input into the answer generation model.

The answer generation unit 34 generates an answer to a question related to a recognized occupant by inputting an image selected by the selection unit 33 as input, identifying information of the recognized occupant, and the question into the answer generation model.

In the present embodiment, the answer generation model is configured as a VLM. The VLM that is the answer generation model is configured, for example, as a combination of an image encoder that encodes an inputted image and a large language model (LLM) with multiple stacked blocks each including an attention layer and a feed forward layer. The answer generation unit 34 adds text data representing identifying information of the recognized occupant (e.g., the occupant's name) to the head or end of the question to combine the identifying information and the question into a single piece of text data, and then inputs the data into the answer generation model. When the input into the answer generation model selected by the selection unit 33 also includes positional information of an occupant, the answer generation unit 34 further adds the coordinates in the image indicated by the positional information or text data representing the sitting position of the occupant (e.g., “driver's seat,” “passenger seat,” or “left rear seat”) to the head or end of the question, together with the text data representing identifying information of the occupant.

When a pre-processed image that is masked except the human region of a particular occupant is selected as input into the answer generation model, the answer generation unit 34 crops only the human region representing the occupant from the image or substitutes the values of pixels other than the human region with a predetermined pixel value, thereby generating a pre-processed image that is masked except the human region. The answer generation unit 34 then inputs the pre-processed image into the answer generation model. When the whole image is selected as input into the answer generation model, the answer generation unit 34 inputs the whole image into the answer generation model.

For example, assume that there are three occupants A, B, and C in the vehicle 1. When the question is “Does everyone look hot?” the answer generation model generates and outputs text data representing an answer such as “Mr. A, Mr. B, and Mr. C all look hot.” by referring to the whole image and identifying information of the individual occupants represented in the image, together with text data representing the question. When the question is “Is Mr. A sleeping?” the answer generation model generates and outputs text data representing an answer such as “Yes” or “Mr. A is sleeping.” by referring to the human region representing A and identifying information of the individual occupants represented in the image, together with text data representing the question. When the question is “Who is Mr. A talking with?” the answer generation model generates and outputs text data representing an answer such as “Mr. A is talking with Mr. B.” or “Mr. A is talking with the person on his right.” by referring to the whole image, positional information of occupant A, and identifying information of the individual occupants represented in the image, together with text data representing the question.

The question inputted into the answer generation model may be independent of occupants recognized from an image. In this case, the answer generation model is pre-trained to generate an answer to a question, independently of an inputted image and identifying information of occupants.

The answer generation unit 34 outputs text data representing the generated answer to the notification processing unit 35.

The notification processing unit 35 outputs the answer to the question via the notification device 4. For example, the notification processing unit 35 generates a voice signal representing the answer in accordance with a predetermined speech synthesis technique, based on the text data representing the answer received from the answer generation unit 34. The notification processing unit 35 then outputs the generated voice signal to the speaker included in the notification device 4, causing the speaker to output a voice representing the answer. Alternatively, the notification processing unit 35 causes the text data representing the answer to appear on the display included in the notification device 4.

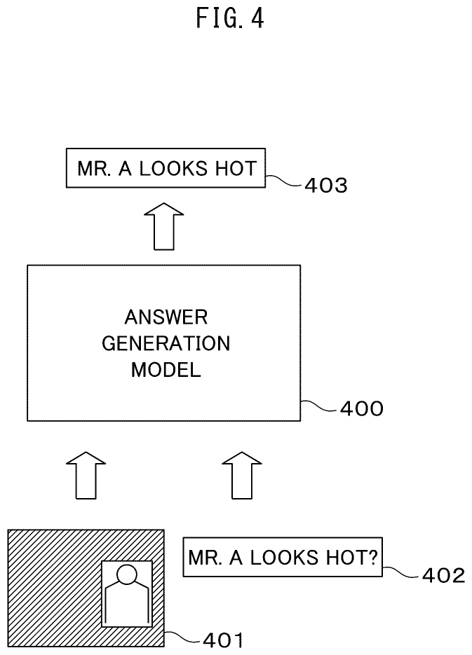

FIG. 4 is a diagram for explaining input and output of the answer generation model of the present embodiment. In the present embodiment, an image 401 selected by the selection unit 33 (the whole image or a pre-processed image) and text data 402 representing identifying information of an individual occupant represented in the image and a question are inputted into an answer generation model 400. As described above, the text data 402 may include positional information of an occupant related to the question. The answer generation model 400 outputs text data 403 representing an answer to the question by referring to the inputted image 401 and text data 402.

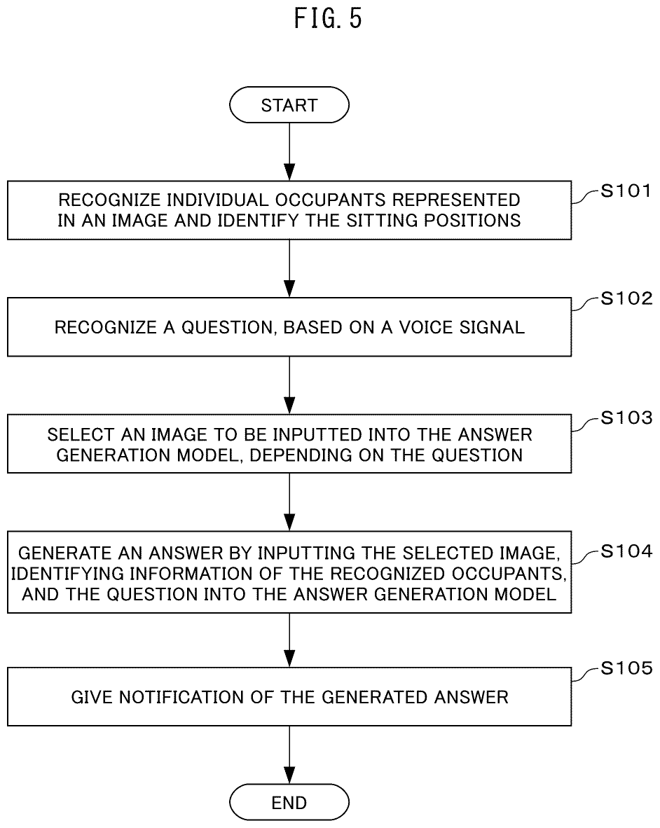

FIG. 5 is an operation flowchart of the auto reply process of the present embodiment. The processor 23 executes the auto reply process in accordance with this operation flowchart.

The image recognition unit 31 recognizes individual occupants represented in an image generated by the camera 2 and identifies the sitting positions of the recognized occupants (step S101). The voice recognition unit 32 recognizes a question asked by one of the occupants, based on a voice signal representing a voice inside the vehicle 1 (step S102).

The selection unit 33 selects an image to be inputted into the answer generation model, depending on the question (step S103). The answer generation unit 34 generates an answer to the question related to a recognized occupant by inputting the selected image, identifying information of the recognized individual occupants, and the question into the answer generation model (step S104). The notification processing unit 35 notifies the generated answer to the occupant via the notification device 4 (step S105).

As has been described above, the auto reply device recognizes one of at least one person represented in an image, and generates an answer to a question related to a recognized person by inputting identifying information for identifying the recognized person, the image, and the question into a model that has been trained to generate the answer. The auto reply device can therefore generate an appropriate answer to a question about a particular person represented in an image.

According to a modified example, positional information indicating the positions of the recognized individual occupants may be inputted into the answer generation model, together with the image, identifying information of the recognized occupants, and the question, regardless of the result of selection by the selection unit 33. This enables the answer generation model to generate an appropriate answer even when the question requires answering identifying information of an occupant satisfying a particular condition.

According to another modified example, the answer generation unit 34 may input the whole image into the answer generation model, together with identifying information of the recognized individual occupants and the question, regardless of the question. In this case, the answer generation unit 34 also preferably inputs positional information of the recognized individual occupants into the answer generation model. In the case of this modified example, the answer generation model is pre-trained so that an appropriate answer to a question about one of occupants represented in an image can be generated even when the whole image is inputted.

Alternatively, the answer generation unit 34 may generate a pre-processed image by masking the image except the human regions of the recognized individual occupants, regardless of the question, and input the generated pre-processed image into the answer generation model, together with identifying information of the recognized individual occupants and the question. In this modified example, the processing of the selection unit 33 may be omitted.

According to still another modified example, the answer to the question may be used for executing control of the vehicle 1 or a device mounted on the vehicle 1. In this case, the answer generation model outputs text data representing details of control. The answer generation unit 34 determines a device to be controlled and a control command by referring to a reference table representing the correspondence between text data representing details of control, a device to be controlled (including the vehicle 1 itself), and a control command for executing the control. The answer generation unit 34 then outputs the determined control command to a control unit of the device to be controlled, via the communication interface 21.

The auto reply device is not limited to automotive embodiments and is usable in various systems capable of capturing multiple persons and required to generate an answer to a question about one of these persons. For example, the auto reply device may be installed in a predetermined space within a facility and generate an answer to a question about one or more persons in this space. Further, the question may be inputted via a user interface that enables input of text data, such as a keyboard or a touch screen. In this case, the processing of the voice recognition unit 32 may be omitted.

The computer program for achieving the auto reply process of the above-described embodiment or modified examples may be provided in a form recorded on a computer-readable portable storage medium.

As described above, those skilled in the art may make various modifications according to embodiments within the scope of the present invention.

What is claimed is:

1. An auto reply device comprising:
a processor configured to:
recognize one of at least one person represented in an image; and
generate an answer to a question related to a recognized person by inputting identifying information for identifying the recognized person, the image, and the question into a generation model that has been trained to generate the answer.

2. The auto reply device according to claim 1, wherein the processor further inputs positional information indicating the position of a human region representing the recognized person in the image into the generation model, together with the question.

3. The auto reply device according to claim 1, wherein the processor pre-processes an image to mask the image except a human region representing the recognized person in the image, and uses the pre-processed image as the image to be inputted into the generation model.

4. The auto reply device according to claim 1, wherein the processor is further configured to select whether the whole of the image or a pre-processed image obtained by pre-processing the image is to be inputted into the generation model, depending on the question, wherein
the processor inputs the whole of the image or the pre-processed image, whichever is selected, into the generation model.

5. The auto reply device according to claim 4, wherein the processor further selects whether positional information indicating the position of a human region representing the recognized person in the image is to be inputted into the generation model, depending on the question, and
the processor further inputs the positional information into the generation model when the positional information is selected as input into the generation model.

6. An auto reply method comprising:
recognizing one of at least one person represented in an image; and
generating an answer to a question related to a recognized person by inputting identifying information for identifying the recognized person, the image, and the question into a generation model that has been trained to generate the answer.

7. A non-transitory recording medium that stores a computer program for auto reply, the computer program causing a computer to execute a process comprising:
recognizing one of at least one person represented in an image; and
generating an answer to a question related to a recognized person by inputting identifying information for identifying the recognized person, the image, and the question into a generation model that has been trained to generate the answer.
